(19) United States
(12) Patent Application Publication
(10) Pub. No.: US 2005/0263358 A1
(43) Pub. Date: Dec. 1, 2005

(54) Hatless brake rotor

(76) Inventor: Akram R. Zahdeh, Davisburg, MI (US)

Correspondence Address: LAURA C. HARGITT;General Motors Corporation, Legal Staff, Mail Code 482-C23-B21, P.O. Box 300, Detroit, MI, 48265-3000, US

(21) Appl. No.: 10/853,463

(22) Filed: May 25, 2004

(51) Int. Cl. F16D 65/10

(52) U.S. Cl. 188/218 XL; 188/18 A

(57) ABSTRACT

A hatless rotor for an automotive disk brake system, wherein the following improvements are realized over known disk brake systems: reduced braking noise, improved air cooling, decoupling of wheel to rotor cross-talk, reduced brake pulsation, reduced mass, reduced rotor cheeks temperature during braking, and better air movement access for improved cooling of the rotor cheeks. The hatless rotor includes a first rotor cheek, a second rotor cheek and a central disk, wherein the first and second rotor cheeks are spaced from, and mutually interconnected to, the central disk by first and second sets of vanes, staggered relative to each other, and configured to provide optimal air circulation. The central rotor disk is connected directly to the motor vehicle axle hub via a suitable rotor hub connected thereto.

### TECHNICAL FIELD

The present invention relates to braking systems used for motor vehicle applications, and more particularly to motor vehicle disk brake systems. Still more particularly, the present invention relates to a hatless rotor for a motor vehicle disk brake system, featuring double rotor cheeks, constant cross-sectional area air passages, and staggered vanes.

### BACKGROUND OF THE INVENTION

Motor vehicle disk brake systems utilize, at each wheel, a “rotor” connected to an axle hub of a rotatable axle of the motor vehicle, and an opposing set of selectively movable brake pads connected to a non-rotating component of the motor vehicle. The rotor includes a disk shaped rotor “cheek” having opposing brake pad engagement surfaces, wherein when braking is to occur, the braking system causes the brake pads to press upon respective brake pad engagement surfaces of the rotor cheek. Frictional interaction between the rotating rotor cheek and non-rotating brake pads causes braking of the motor vehicle to transpire, the rate of braking depending upon the pressure of the brake pads against the rotor cheek.

It is common practice for the rotor to be mounted to the motor vehicle axle via a rotor “hat”. The rotor hat is essentially a cup shaped member which spans an inner diameter of the rotor cheek, providing stud receiving holes and a complementing shape to the axle hub for mounting the rotor to the axle hub.

It is further preferred that the rotor cheek be air cooled as heat of braking is generated. Air cooling is provided by the rotor being composed of two rotor cheeks which are mutually separated by a spacing and mutually configured with respect to the rotor hat such that as the rotor turns, air flows radially outward through the spacing so as to thereby cool the rotor cheeks. In this regard, an outer side of one rotor cheek is provided with one brake pad engagement surface, and the outer surface of the other rotor cheek is provided with another brake pad engagement surface, the two brake pad engagement surfaces engaging a pair of brake pads as described above. In order to facilitate the radial movement of the air and also provide structural stability to the rotor cheeks, a plurality of radially oriented “vanes” (also referred to as “webs”) are provided, spanning between, and attached to, the inner surface of each of the rotor cheeks. Advantageously, the vanes may provide air passageways which have substantially constant cross-section.

A brake rotor having all the aforedescribed advantageous features is described in U.S. Pat. No. 6,401,880 B1, issued Jun. 11, 2002 to the assignee hereof.

One disadvantage of disk brakes is the potential for generation of noise during braking. Low frequency brake noise (100 to 1,000 Hz) creates the perception of a grunt, moan or groan sound. High frequency brake noise (1 to 12 kHz) creates the perception of a squeal sound. Any of these sounds are objectionable, and their elimination is very desirable. Brake noise is triggered mainly by a change in the brake friction characteristic, having a number of origins, including: relative rotational speed between the brake pads and the rotor; brake pad pressure on the rotor cheeks; brake components geometry (particularly the rotor); temperature changes during braking (which effect can cause changes in the coefficient of friction between the rotor cheeks and the brake pads); the relative orientation of the brake pads to the rotor cheeks; brake pad stick to the rotor cheeks at release; inherent friction instability between the rotor cheeks and the brake pads, due to, for example, gaps, slacks and non-uniform brake pad loading, resulting in brake flutter; choice of brake pad material; road load cross-talk between the wheel and the rotor; and, particularly as regards a moderately wide noise frequency (1 to 5 kHz), transverse vibration of the rotor cheeks which plays a predominant role in “squeal”.

With regard to the orientation of the brake pads relative to the brake pad engagement surfaces of the rotor cheeks, because the rotor cheeks have a cantilevered connection to the rotor hat, rotation of the axle results in a centrifugal force applied to the rotor cheeks which causes the rotor cheeks to become oriented off-perpendicular with respect to the rotational axis of the axle. Further, the pressure of the brake pads upon the rotor cheeks adds to this effect, known as “coning”.

Accordingly, what remains needed in the art of automotive brakes is to somehow provide a disk brake which features the following improvements as compared to known disk brakes: reduced braking noise, improved air cooling, decoupling of wheel to rotor cross-talk with respect to road load input, reduced brake pulsation, reduced mass, reduced temperature of the brake pad engagement surfaces during braking which translates into elongation of life of the rotor and the brake pads, and better air movement access as between the inner and outer rotor cheek perimeters which thereby minimizes hot air recirculation.

### SUMMARY OF THE INVENTION

The present invention is a hatless rotor for an automotive disk brake system, wherein the following improvements are realized over known disk brake systems: reduced braking noise, improved air cooling, decoupling of wheel to rotor cross-talk, reduced brake pulsation, reduced mass, reduced rotor cheeks temperature during braking, and better air movement access for improved cooling of the rotor cheeks.

The hatless rotor according to the present invention includes a first rotor cheek, a second rotor cheek and a central disk, wherein the first and second rotor cheeks are spaced from, and mutually interconnected with, the central disk by a plurality of vanes (or webs), wherein a first set of vanes interconnects the first rotor cheek to the central disk, and a second set of vanes interconnects the second rotor cheek to the central disk. The vanes are configured to provide optimal air circulation between the first and second rotor cheeks and the central disk, respectively. The first and second sets of vanes are staggered relative to each other. There is no rotor hat, rather the central rotor disk is connected directly to the motor vehicle axle hub via a suitable rotor hub connected thereto.

As mentioned hereinabove, brake noise is triggered mainly by the change in friction characteristic with speed, geometry, temperature change and relative orientation of the rotor cheeks to the brakes pads, which effects are worsened if there is coning. The hatless rotor according to the present invention solves these problems as follows. To eliminate centrifugal forces which aid to coning, there is no rotor hat, wherein the central disk, which defines a central plane of the rotor, is bolted directly to the axle hub. To decouple road load cross-talk between the wheel and the rotor, the rotor is not sandwiched between the axle hub and the wheel; rather, the rotor is bolted directly to the axle hub with its own fasteners. To regulate temperature, the rotor vanes are shaped akin to elongated tear-drops (a generally pointed radially inner end, increasing in width to a convex radially outer end) so as to provide a constant cross sectional area of the air passages between the rotor cheeks and thereby provide more efficient cooling by eliminating air flow separation in the vanes and increasing an air pumping effect through the air passages (thereby increasing rotor and brake pad life). To cancel monotonous harmonics induced by the vanes as the rotor rotates, the first set of vanes is staggered with respect to the second set of vanes. To additionally regulate temperature, additional metal of the vanes is located near the radially outer perimeter of the rotor which thereby serves to increase the useful thermal mass/inertia (heat capacity) of the rotor at the outer perimeter thereof, which is generally the hottest portion of the rotor during braking.

Thus, the hatless rotor according to the present invention provides, among others, the following main advantages. By eliminating the rotor hat, there is now a minimum effect of centrifugal force on the rotor cheeks orientation: the center of mass of the rotor is located on the central plane of the rotor which results in minimization of bending and coning when the rotor is rotating which thereby translates into minimization of frictional instability and reduction of high and low frequency noise generation during braking. The staggering of the first set of vanes relative to the second set of vanes serves to increase rotor stiffness and cancel out repeatable harmonics. The constant cross-sectional area of the air passages between the central disk and the first and second rotor cheeks, as well as an open air access to the air passages at both the inner and outer perimeters of the rotor, serve to improve rotor cheek cooling by eliminating air flow separation and increasing heat transfer to the atmosphere, while also facilitating debris pass-through. Finally, by eliminating the rotor hat and directly attaching the rotor to the axle hub, there is provided decoupling of road load cross-talk between the wheel and the rotor.

Accordingly, it is an object of the present invention to provide a hatless rotor for a disk brake system of a motor vehicle which reduces generation of brake noise, as well as other undesirable effects, as compared with conventional rotors for disk brake systems.

This and additional objects, features and advantages of the present invention will become clearer from the following specification of a preferred embodiment.

### BRIEF DESCRIPTION OF THE DRAWINGS

FIG. 1 is a perspective view of a portion of a motor vehicle disk brake system, wherein at a wheel location of the disk brake system, the hatless rotor according to the present invention is interfaced therewith.

FIG. 2 is a plan view of the hatless rotor according to the present invention connected to a rotor hub therefor.

FIG. 3 is a sectional view taken along line 3-3 in FIG. 2.

FIG. 4 is an end view of the hatless rotor according to the present invention.

FIG. 5 is a partly sectional view, seen along line 5-5 in FIG. 4.

FIG. 6 is a partly sectional view, seen along line 6-6 in FIG. 4.

FIG. 7 is a schematic plan view of the hatless rotor according to the present invention, circumferentially showing the staggering of the first and second sets of vanes thereof relative to each other.

FIG. 8 is a first broken-away, partly sectional perspective view of the hatless rotor according to the present invention.

FIG. 9 is a second broken-away, partly sectional perspective view of the hatless rotor according to the present invention.

### DESCRIPTION OF THE PREFERRED EMBODIMENT

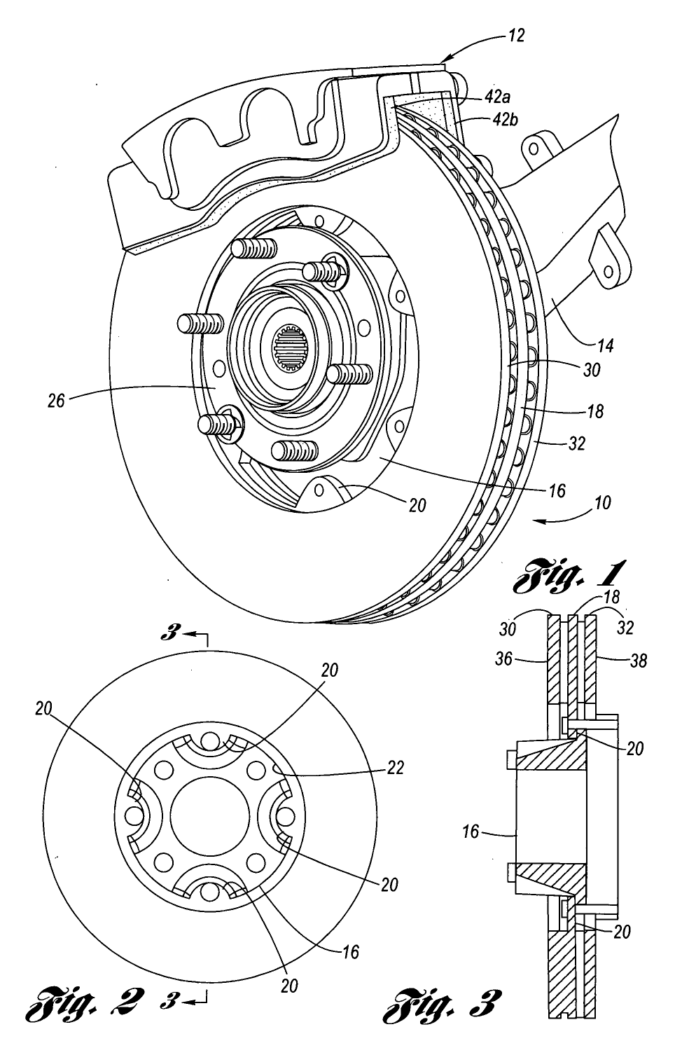

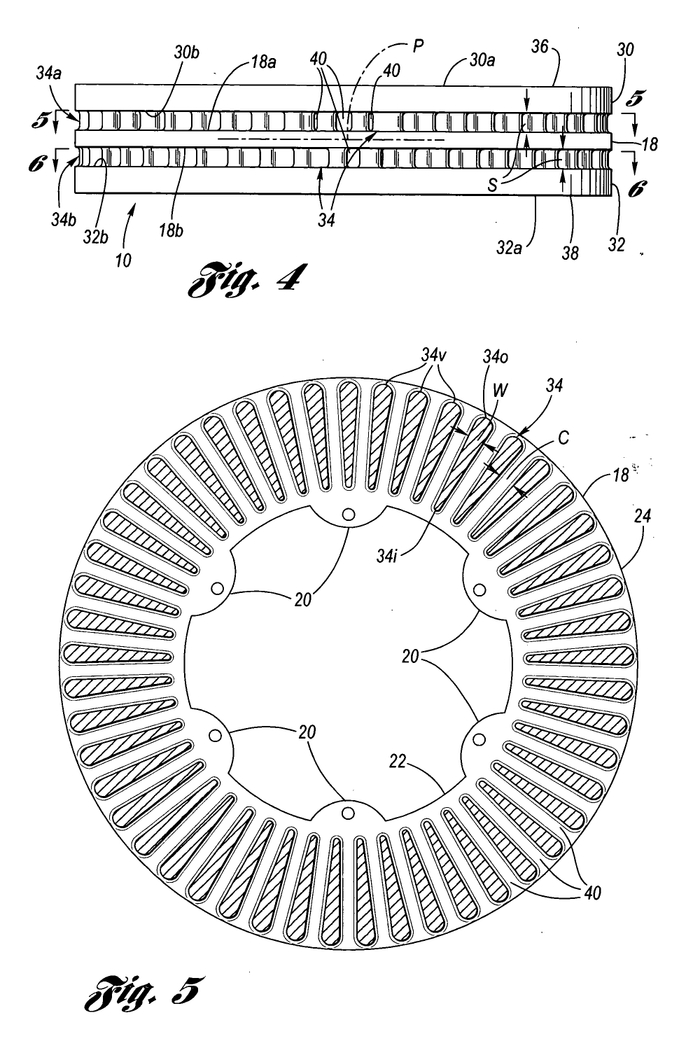

Referring now to the Drawing, FIGS. 1 through 3 depict various aspects of a preferred example of a hatless rotor 10 according to the present invention which is operatively integrated with a disk brake system 12 of a motor vehicle at a wheel location thereof. The axle 14 has an axle hub (not visible) to which is directly connected a rotor hub 16. The rotor hub 16 is, in turn, connected to an annularly shaped central disk 18 of the hatless rotor 10, via a plurality of mounting tabs 20 (by way of example six mounting tabs are shown in FIGS. 1, 5 and 7 and four mounting tabs are shown with the hatless rotor of FIG. 2) which are located at an inner rotor perimeter 22, and on the central plane P (see FIG. 4), of the hatless rotor. It will be seen that since the hatless rotor 10 is mounted directly to the axle hub via the rotor hub 16, that the wheel hub 26 connects directly to the axle hub independently of the direct connection of the hatless rotor to the axle hub. This feature isolates road load experienced by the wheel from transferring to the hatless rotor 10, a process known as “cross-talk” which will be further discussed hereinbelow.

Referring now additionally to FIG. 4, it will be understood that the hatless rotor 10 is composed of an annularly shaped first rotor cheek 30, an annularly shaped second rotor cheek 32 and the aforementioned central disk 18. Connecting the first and second rotor cheeks 30, 32 to the central disk, at respectively opposite sides thereof, is a plurality of vanes (or webs) 34. At an outer side 30a of the first rotor cheek 30 is a first brake pad engagement surface 36, and at the outer side 32a of the second rotor cheek 32 is a second brake pad engagement surface 38. As shown at FIG. 1, the brake pads 42a, 42b of the disk brake system 12 are selectively pressable upon the first and second brake pad engagement surfaces 36, 38, respectively in order to provide braking for the motor vehicle.

The first rotor cheek 30 is connected the central disk 18 via a first set of vanes 34a of the plurality of vanes 34 being fixedly connected to an inner side 30b of the first rotor cheek and a first side 18a of the central disk. The second rotor cheek 32 is connected the central disk 18 via a second set of vanes 34b of the plurality of vanes 34 being fixedly connected to an inner side 32b of the second rotor cheek and a second side 18b of the central disk.

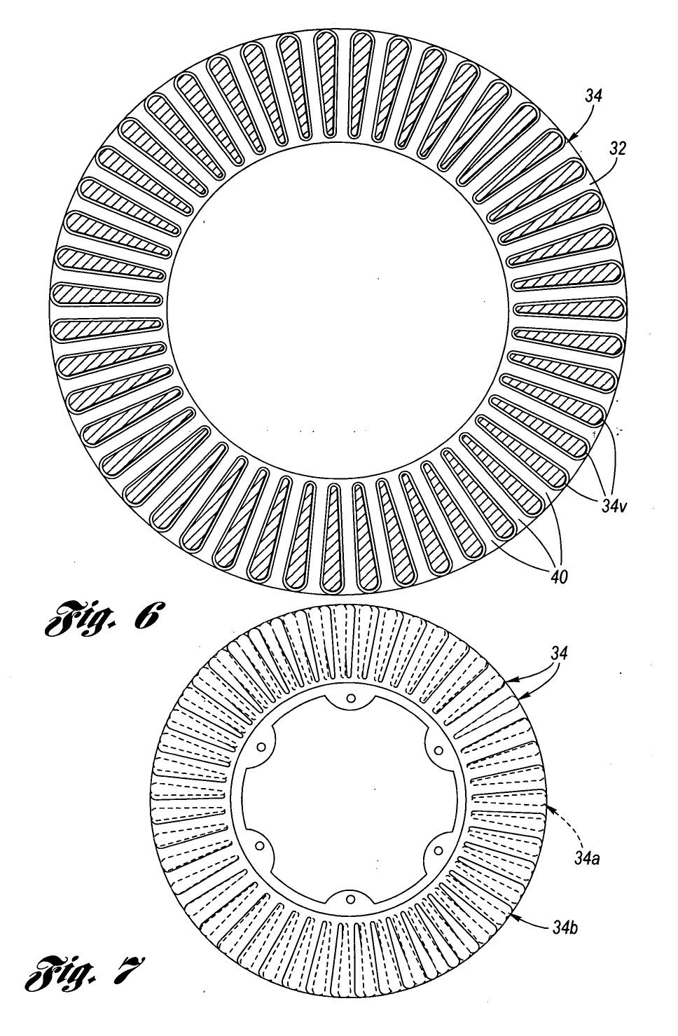

Referring next additionally to FIGS. 5 through 9, the structure and function of the plurality of vanes 34, vis-a-vis the first and second rotor cheeks 30, 32 and the central disk 18, will now be further detailed.

Each vane 34v of the plurality of vanes 34 is preferably identical, having a width W (see FIG. 5) parallel to the central plane P, wherein the width increases from a minimum adjacent the inner rotor perimeter 22 to a maximum adjacent the outer rotor perimeter 24. The preferred shape of each vane 34v is in the form of an elongated tear drop shape characterized by a pointed inner end 34i and a convex outer end 34o. Each vanes 34v of each of the first and second sets of vanes 34a, 34b is mutually separated from its respectively adjacent vane by a spacing S (see FIG. 4). Accordingly, the plurality of vanes 34 provide a first set of air passages 40a (see FIG. 9) between the first rotor cheek 30 and the central disk 18, and a second set of air passages 40b between the second rotor cheek 32 and the central disk. As can be clearly discerned by review of FIGS. 4 through 6, owing to the aforesaid shape of each of the vanes 34v, each air passage 40 of the first and second sets of air passages 40a, 40b has a generally constant cross-section C (see FIG. 5) parallel to the central plane P, and that, since the separation S as between the first rotor cheek 30 and the second rotor cheek 32 with respect to the central disk 18 is constant (that is, the separation S perpendicular to the central plane P is constant), that the cross-sectional area A (see FIG. 9) of each air passage 40 is constant extending from the inner rotor perimeter 22 to the outer rotor perimeter 24.

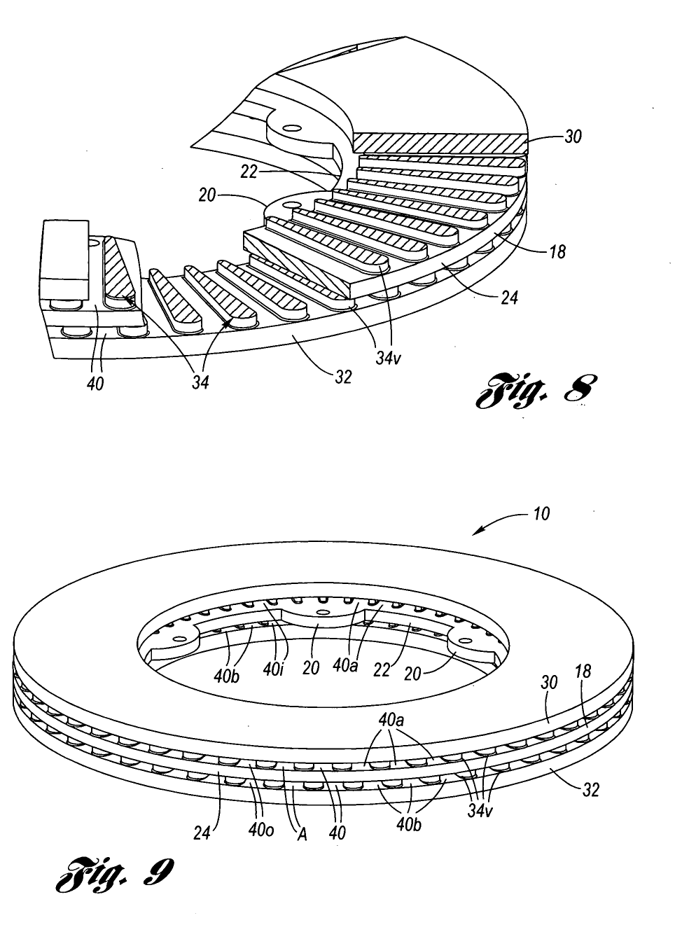

It is preferred to stagger the placement of each of the vanes 34v of the first set of vanes 34a with respect to the vanes of the second set of vanes 34b, as shown schematically at FIG. 7. In this regard, it is preferred to provide the staggering of the vanes 34v by changing the number of vanes as between the first and second sets of vanes 34a, 34b. Most preferably, it is preferred to stagger the vanes 34v as between the first and second sets of vanes 34a, 34b by having an odd number of vanes in both the first and second sets of vanes, and then have one or the other of the first and second sets of vanes to have two less vanes than the other set of vanes. For example, the first set of vanes 34a could have 49 vanes and the second set of vanes 34b would then have 47 vanes. The arrangement of the vanes 34v may be as described in U.S. Pat. No. 6,401,880 B1, referenced hereinabove, which patent document is hereby herein incorporated by reference.

The synergistic result of the foregoing structural aspects of the hatless rotor 10 according to the present invention, a number of beneficial results are provided, including those discussed hereinbelow.

Brake noise is triggered mainly by the change in friction characteristic with speed, geometry, temperature change and relative orientation of the rotor cheeks to the brakes pads, which effects are worsened if there is coning. The hatless rotor 10 solves these problems as follows. To eliminate centrifugal forces which aid to coning, there is no rotor hat, wherein the central disk 18, which defines a central plane P thereof, is bolted directly to the axle hub. To decouple the rotor to wheel road load cross-talk, the hatless rotor 10 is not sandwiched between the axle hub and the wheel; rather, the hatless rotor is bolted directly to the axle hub with its own fasteners. To regulate temperature, the vanes 34v are shaped like tear-drops so as to provide constant cross section of the air passages 40 between the first and second rotor cheeks 30, 32 and the central disk 18, respectively, to provide more efficient cooling by eliminating air flow separation in the vanes and increasing an air pumping effect through the air passages (thereby increasing hatless rotor and brake pad life). To cancel monotonous harmonics induced by the vanes 34v as the hatless rotor rotates, the first set of vanes 34a is staggered with respect to the second set of vanes 34b. To additionally regulate temperature, additional of metal of the vanes near the radially outer perimeter 24 of the hatless rotor increases the useful thermal mass/inertia (heat capacity) of the rotor at the outer perimeter thereof, which is generally the hottest portion of the hatless rotor during braking.

Thus, the hatless rotor 10 provides, among others, the following main advantages.

By eliminating the rotor hat, there is no cantilevered connection of the first and second rotor cheeks 30, 32 to the axle hub. Accordingly, there is now a minimum effect of centrifugal force on the first and second rotor cheeks 30, 32, wherein the center of mass of the hatless rotor 10 is located on the central plane P thereof. This aspect consequently results in minimization of bending and coning when the hatless rotor is rotating, which thereby translates into minimization of frictional instability and reduction of high and low frequency noise generation during braking.

The staggering of the first set of vanes 34a relative to the second set of vanes 34b serves to increase stiffness of the first and second rotor cheeks 30, 32, with the consequence that repeatable harmonics are cancelled.

The constant cross-sectional area A of each of the air passages 40 of the first and second sets of air passages 40a, 40b, as well as an open air access 40i, 40o (see FIG. 9) to the air passages at both the inner and outer perimeters 22, 24 of the hatless rotor 10, serve to improve cooling of the first and second rotor cheeks 30, 32 by eliminating air flow separation and increasing heat transfer to the pass-through air, while also facilitating debris pass-through.

Finally, by eliminating the rotor hat and directly attaching the hatless rotor 10 to the axle hub, there is provided decoupling of cross-talk of road load acquired by the wheel with respect to hatless rotor 10.

To those skilled in the art to which this invention appertains, the above described preferred embodiment may be subject to change or modification. For example any combination of the configurations of the vanes (webs) and air passages (passageways) described in U.S. Pat. No. 6,401,880 may be adopted for use in the hatless rotor 10. Such change or modification can be carried out without departing from the scope of the invention, which is intended to be limited only by the scope of the appended claims.

1. A hatless rotor, comprising:
an annular first rotor cheek having an outer side and an opposite inner side, a first brake pad engagement surface being located at said outer side of said first cheek;
an annular second rotor cheek having an outer side and an opposite inner side, a second brake pad engagement surface being located at said outer side of said second rotor cheek;
an annular central disk located between said first and second rotor cheeks in spaced relation thereto, said central disk having a first side and an opposite second side;
a first set of vanes connected to said inner side of said first rotor cheek and said first side of said central disk, wherein said first set of vanes consists of a first odd number of vanes; and
a second set of vanes connected to said inner side of said second rotor cheek and said second side of said central disk, wherein said second set of vanes consists of a second odd number of vanes, and wherein said first odd number is different from said second odd number;
wherein a central plane bisects said central disk, and wherein a center of gravity of said hatless rotor lies generally on said central plane; and
wherein each of said first rotor cheek, said second rotor cheek and said central disk are free of a rotor hat.

2. The hatless rotor of claim 1, wherein said first set of vanes is staggered in relation to said second set of vanes.

3. (canceled)

4. The hatless rotor of claim 2, wherein the staggering of said first set of vanes in relation to said second set of vanes is provided by one of said first and second sets of vanes having two fewer vanes than the other of said first and second sets of vanes.

5. (canceled)

6. The hatless rotor of claim 1, wherein each vane of each of said first and second sets of vanes is shaped to provide a substantially constant cross-sectional area air passage bounded by mutually adjacent vanes, said central disk and one of said first and second rotor cheeks, wherein each of said air passages is open at each end and extends substantially between an inner perimeter and an outer perimeter of said hatless rotor.

7. The hatless rotor of claim 6, wherein said predetermined shape is a generally elongated tear drop shape wherein a width parallel to said central plane increases radially from said inner perimeter to said outer perimeter.

8. The hatless rotor of claim 7, wherein an inner end of each said vane adjacent said inner perimeter is substantially pointed arid an outer end thereof adjacent said outer perimeter is substantially convex.

9. The hatless rotor of claim 2, further comprising said central disk having a plurality of mounting tabs located at said inner perimeter and oriented in the central plane.

10. The hatless rotor of claim 9, wherein each vane of each of said first and second sets of vanes is shaped to provide a substantially constant cross-sectional area air passage bounded by mutually adjacent vanes, said central disk and one of said first and second rotor cheeks, wherein each of said air passages is open at each end and extends substantially between an inner perimeter and an outer perimeter of said hatless rotor.

11. The hatless rotor of claim 10, wherein the staggering of said first set of vanes in relation to said second set of vanes is provided by one of said first and second sets of vanes having two fewer vanes than the other of said first and second sets of vanes.

12. The hatless rotor of claim 11, wherein said predetermined shape is a generally elongated tear drop shape wherein a width parallel to said central plane increases radially from said inner perimeter to an outer perimeter.

13. The hatless rotor of claim 12, wherein an inner end of each said vanes adjacent said inner perimeter is substantially pointed and an outer end thereof adjacent said outer perimeter is substantially convex.

14. (canceled)

15. A hatless rotor, comprising:
an annular first rotor cheek having an outer side and an opposite inner side, a first brake pad engagement surface being located at said outer side of said first rotor cheek;
an annular second rotor cheek having an outer side and an opposite inner side, a second brake pad engagement surface being located at said outer side of said second rotor cheek;
an annular central disk located between said first and second rotor cheeks in spaced relation thereto, said central disk having a first side and an opposite second side, said central disk being bisected by a central plane of said hatless rotor, said central disk having a plurality of mounting tabs located in said central plane and at an inner perimeter of said hatless rotor;
a first set of vanes connected to said inner side of said first rotor cheek and said first side of said central disk; and
a second set of vanes connected to said inner side of said second rotor cheek and said second side of said central disk;
wherein said first set of vanes is staggered in relation to said second set of vanes; and
wherein said hatless rotor is configured to be removably attachable, free of a rotor hat, to a drive member only via said mounting tabs of said central disk.

16. The hatless rotor of claim 15, wherein said first and second sets of vanes each has an odd number of vanes, wherein the staggering of said first set of vanes in relation to said second set of vanes is provided by one of said first and second sets of vanes having fewer vanes than the other of said first and second sets of vanes.

17. The hatless rotor of claim 16, wherein each vane of each of said first and second sets of vanes is shaped to provide a substantially constant cross-sectional area air passage bounded by mutually adjacent vanes, said central disk and one of said first and second rotor cheeks, wherein each of said air passages is open at each end and extends substantially between an inner perimeter and an outer perimeter of said hatless rotor.

18. The hatless rotor of claim 17, wherein said predetermined shape is a generally elongated tear drop shape wherein a width parallel to said central plane increases radially from said inner perimeter to said outer perimeter.

19. The hatless rotor of claim 18, wherein said first and second sets of vanes each has an odd number of vanes, wherein the staggering of said first set of vanes in relation to said second set of vanes is provided by one of said first and second sets of vanes having fewer vanes than the other of said first and second sets of vanes.

20. The hatless rotor of claim 19, wherein:
an inner end of each aid vanes adjacent said inner perimeter is substantially pointed and an outer end thereof adjacent said outer perimeter is substantially convex;
said fewer vanes comprises two fewer vanes; and
a center of gravity of the hatless rotor lies generally on said central plane.
